(19) United States
(12) Patent Application Publication
(10) Pub. No.: US 2017/0017968 A1
(43) Pub. Date: Jan. 19, 2017

(54) Systems and Methods for Use in Valuing Coupons, Relative to Other Coupons

(71) Applicant: MASTERCARD INTERNATIONAL INCORPORATED, Purchase, NY (US)

(72) Inventors: Manash Bhattacharjee, Jersey City, NJ (US); Debashis Ghosh, Charlotte, NC (US)

(21) Appl. No.: 14/798,434

(22) Filed: Jul. 13, 2015

(51) Int. Cl. G06Q 30/02; G06F 17/30

(52) U.S. Cl. CPC G06Q 30/0201; G06Q 30/0278; G06F 17/3053

(57) ABSTRACT

Systems and methods are provided for assigning a value to a coupon, suited for ranking the coupon relative to other coupons. One exemplary method generally includes selecting, by a computing device, a target coupon; weighting, by the computing device, a value associated with the coupon, based on at least one parameter related to the coupon and/or a redemption merchant associated with the coupon; and publishing the weighted value of the target coupon, whereby the weighted value is usable to compare the target coupon to weighted values of other coupons.

### FIELD

The present disclosure generally relates to systems and methods for valuing coupons, relative to other coupons, and, more particularly, to assigning and weighted values to the coupons, such that the coupons maybe additionally ranked and/or compared, relative to the other coupons, based on the assigned values.

### BACKGROUND

This section provides background information related to the present disclosure which is not necessarily prior art.

Product purchases at merchants, by consumers, may be accompanied, in some instances, with the presentation of coupons, by which prices associated with the purchased products (e.g., goods and services) may be reduced. The coupons are known to be circulated by the merchants, and collected by the consumers. The coupons may offer, for example, percentages off the purchase prices (e.g., 5% off), dollar amounts off the purchase prices (e.g., $5 off), or buy one, get one free offers or promotions for certain products, or for multiple products. The consumers attempt to not only maximize savings by using the coupons, but to also seek maximum value coupons for products in which the consumers are interested. Often, the consumers even register for coupon services, such as, Groupon®, for example, through which coupons are published and provided to the consumers.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in assigning values to coupons, based on a variety of parameters associated with the coupons;

FIG. 2 is a block diagram of a computing device, that may be used in the exemplary system of FIG. 1;

FIG. 3 is an exemplary method for assigning values to coupons, suitable for use with the system of FIG. 1; and

FIG. 4 is an exemplary interface that may be used in connection with the system of FIG. 1 and/or the method of FIG. 3 for displaying coupons and assigned values to the coupons.

Corresponding reference numerals indicate corresponding parts throughout the several views of the drawings.

### DETAILED DESCRIPTION

The description and specific examples included herein are intended for purposes of illustration only and are not intended to limit the scope of the present disclosure.

Coupons are often delivered from merchants to consumers (broadly, users), whereby the consumers often receive the coupons for products that they may or may not have interest in purchasing. While the coupons may have value to certain consumers, the coupons may have less value or no value to other consumers who have no intention in making purchases for the particular products to which the coupons are directed. In addition, terms and conditions, as well as face values or discounts, associated with the coupons may affect or change the likelihood that consumers will use them. In addition, coupons, regardless of interest by the consumers, may be exchanged, sold or bought, for example, through coupon exchanges, etc. Without a common metric for comparing different coupons (e.g., for comparing a 20% off coupon to a $5.00 off coupon to a “Buy One Get One Free” coupon, etc.), however, exchanging the different coupons between consumers may be difficult. The methods and systems herein assign values to the coupons, based on face values of the coupons and various weightings that take into account coupon parameters such as value/discount, ease of use, minimum purchase requirements, expiration dates, etc. In addition, the values are normalized between the different types of coupons. In this manner, a common metric, or value scale, is provided, by which the different coupons can more efficiently and accurately be ranked, compared, exchanged, etc.

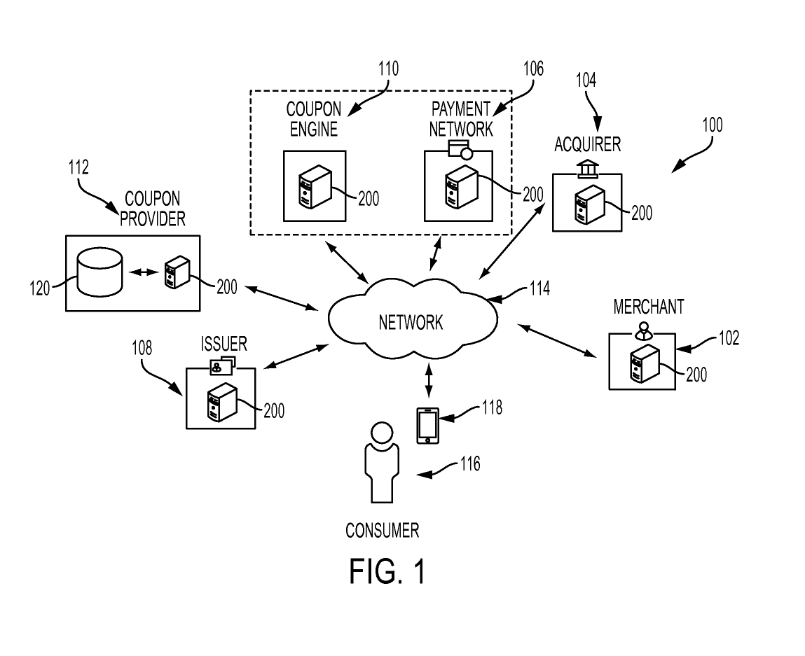

FIG. 1 illustrates an exemplary system 100, in which the one or more aspects of the present disclosure may be implemented. Although the system 100 is presented in one arrangement, other embodiments may include systems arranged otherwise, depending, for example, on manners of distributing and/or redeeming coupons, numbers of merchants, numbers of consumers, etc.

The system 100 generally includes a merchant 102 (e.g., a redemption merchant that accepts coupons in connection with transactions for products, etc.), an acquirer 104, a payment network 106, an issuer 108, a coupon engine 110, and a coupon provider 112, each coupled to network 114. The network 114 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 114 may include multiple different networks, such as a private payment transaction network made accessible by the payment network 106 to the acquirer 104 and the issuer 108 and, separately, the public Internet, which the coupon engine 110, the coupon provider 112, and/or a consumer 116 (via portable communication device 118) may access.

The coupon provider 112 is generally a repository of coupons, in a coupon data structure 120, for one or more merchants or other entities, e.g., product distributors, manufacturers, etc. Each of the coupons, in one or more embodiments, is associated with at least one redemption merchant, i.e., a merchant at which the coupon may be redeemed or used, such as merchant 102. For purposes of the description herein, the coupon provider 112 is a separate entity, separate from a particular merchant, etc. However, in other embodiments, the coupon provider 112 may be incorporated with, or as part of, the merchant 102. Further, in several embodiments, the coupon provider 112 may be incorporated in, or associated with other entities shown or not shown in FIG. 1, etc.

The coupon engine 110 is defined by computer-executable instructions, and is generally configured to assign values to coupons, based on one or more parameters relative to the coupons and/or redemption merchants associated with the coupons. The coupon engine 110 is then also configured to publish the values, for example, to a website associated with the coupon engine 110, etc., or transmit the values to the redemption merchants, or the consumer 116 at the portable communication device 118 so that the coupons and associated values are available to the merchants and/or consumer 116 for subsequent use. Generally, the coupon engine 110 is remote from (i.e., geographically spaced apart from) the communication device 118 associated with the consumer 116. As such, values published by the coupon engine 110, and viewed at the device 118, for example, occurs via one or more networks, such as network 114. Similarly in the system 100, the coupon engine 110 is remote from the merchant 102, such that the merchant 102 may have access to values published by the coupon engine 110

The coupons, which are valued by the coupon engine 110, may include coupons provided/distributed by the coupon provider 112, coupons provided/distributed by the merchant 102, or coupons provided/distributed by other entities. The coupon engine 110 is illustrated as a separate entity in the system 100, separate from the merchant 102 and the payment network 106, etc. However, the coupon engine 110 may be associated with the payment network 106 in some implementations, as indicated by the dotted lines in FIG. 1. In addition, it should be appreciated that in other embodiments the coupon engine 110 may be incorporated in, or associated with, the issuer 108, or another entity shown or not shown in FIG. 1, etc., in other embodiments. Further still, the coupon engine 110, while separate, may be linked to any of the entities in system 100, for example, as an application program interface (API). For example, a coupon exchange website may, in some embodiments, incorporate the coupon engine 110 into the other entities (e.g., coupon provider 112, etc.), via the API.

Separately in the system 100, the consumer 116 is associated with one or more payment accounts, through which the consumer 116 completes transactions for products (using coupons, or not). In particular, the consumer 116 may initiate a transaction by presenting a payment device, such as a credit card, a debit card, a pre-paid card, a payment fob, the communication device 118 with a payment account application, etc. to the merchant 102 or to another merchant. The payment device may be presented at the merchant 102, or remote from the merchant 102, via network 114, for example.

When the payment device is presented by the consumer 116, the merchant 102, in turn, reads the payment device and/or receives payment account information and then communicates an authorization request (e.g., including a payment account number and an amount of the purchase, etc.) to the acquirer 104 to determine (in conjunction with the issuer 108) whether the payment account is in good standing and whether there is sufficient credit or funds to complete the transaction. The acquirer 104, in turn, communicates the authorization request with the issuer 108, through the payment network 106, such as, for example, through MasterCard®, VISA®, Discover®, American Express®, etc. If the issuer 108 accepts the transaction, a reply authorizing the transaction is provided back to the merchant 102, thereby permitting the merchant 102 to complete the transaction. The transaction is later cleared and/or settled by and between the merchant 102, the acquirer 104, and the issuer 108. If the issuer 108 declines the transaction, a reply declining the transaction is provided back to the merchant 102, thereby permitting the merchant 102 to stop the transaction.

The above transaction is described with reference to a credit account. However, it should be appreciated that purchase transactions may further include other transactions, such as debit transactions and pre-paid transactions. For debit and pre-paid accounts, a transaction, and processing thereof, is substantially similar to the above transaction, but may further include the use of a personal identification number (PIN) authorization and/or more rapid posting of the charge to the payment account, etc.

Transaction data is generated, collected, and stored as part of the above interactions among the merchant 102, the acquirer 104, the payment network 106, the issuer 108, and the consumer 116. The transaction data represents at least a plurality of transactions, e.g., completed transactions, attempted transactions, etc. The transaction data, in this exemplary embodiment, is stored at least by the payment network 106 (e.g., in a data structure associated with the payment network 106, etc.). Additionally, or alternatively, the merchant 102, the acquirer 104, and/or the issuer 108 may store the transaction data, or part thereof, in memory, or transaction data may be transmitted between entities of system 100, as used or needed. The transaction data includes, for example, payment account numbers, amounts of the transactions, merchant IDs, merchant category codes, dates/times of the transactions, products purchased and related descriptions or identifiers, products refunded, etc. It should be appreciated that more or less information related to transactions, as part of either authorization and/or clearing and/or settling, may be included in transaction data and stored within the system 100, at the merchant 102, the acquirer 104, the payment network 106, and/or the issuer 108. Further, transaction data unrelated to a payment account may be collected by a variety of techniques, and similarly stored with the system 100.

In various exemplary embodiments, consumers involved in the different transactions herein agree to legal terms associated with their payment accounts, for example, during enrollment in their accounts, etc. In so doing, the consumers may agree, for example, to allow merchants, issuers of the payment accounts, payment networks, etc. to use data collected during enrollment and/or collected in connection with processing the transactions, subsequently for one or more of the different purposes described herein.

While one consumer 114 and one merchant 102 are illustrated in FIG. 1, it should be appreciated that any number of consumers (and associated communication devices) and merchants may be a part of the system 100, or a part of systems in other embodiments, consistent with the present disclosure. Likewise, a different number of acquirers, payment networks, issuers, and/or coupon providers may be included as desired.

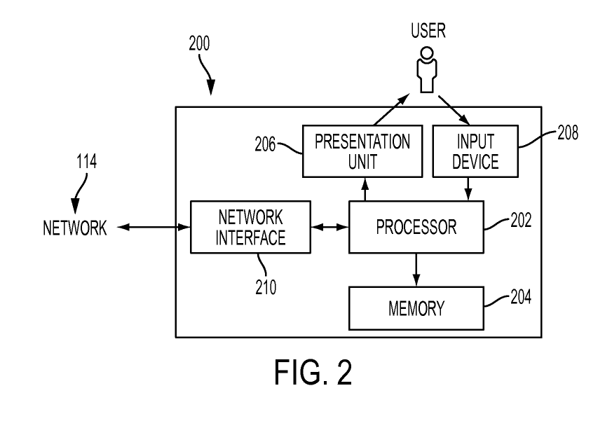

FIG. 2 illustrates an exemplary computing device 200 that can be used in the system 100. The computing device 200 may include, for example, one or more servers, workstations, personal computers, laptops, tablets, smartphones, PDAs, televisions, etc. In addition, the computing device 200 may include a single computing device, or it may include multiple computing devices located in close proximity or distributed over a geographic region. However, the system 100 should not be considered to be limited to the computing device 200, as described below, as different computing devices and/or arrangements of computing devices may be used. In addition, different components and/or arrangements of components may be used in other computing devices.

In the exemplary embodiment of FIG. 1, each of the merchant 102, the acquirer 104, the payment network 106, the issuer 108, the coupon engine 110, and the coupon provider 112 are illustrated as including, or being implemented in, computing device 200, coupled to the network 110. Further, the computing devices 200 associated with these entities, for example, may include a single computing device, or multiple computing devices located in close proximity or distributed over a geographic region. In addition, the portable communication device 118, associated with consumer 116, can also be considered a computing device consistent with computing device 200 for purposes of the description herein.

Referring to FIG. 2, the exemplary computing device 200 includes a processor 202 and a memory 204 coupled to the processor 202. The processor 202 may include one or more processing units (e.g., in a multi-core configuration, etc.). For example, the processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein.

The memory 204, as described herein, is one or more devices that permit data, instructions, etc. to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, coupons, coupon parameters and/or weightings, coupon values, rankings of merchants, rankings of coupons, merchants per category, locations/stores per region per merchant, and/or other types of data suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is identifying and/or presenting coupons to the consumer 114. It should be appreciated that the memory 204 may include a variety of different memories, each implemented in one or more of the functions or processes described herein.

In the exemplary embodiment, the computing device 200 includes a presentation unit 206 that is coupled to the processor 202 (however, it should be appreciated that the computing device 200 could include output devices other than the presentation unit 206, etc.). The presentation unit 206 outputs information (e.g., coupons or indicators of coupons, values or scores of coupons, etc.), either visually or audibly to the user, for example, the consumer 116, etc. It should be further appreciated that various interfaces (e.g., application interfaces, webpages, etc.) may be displayed at computing device 200, and in particular at presentation unit 206, to display information, such as, for example, coupons, exchanges including coupons and associated values, reports on coupon relative values, etc. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

The computing device 200 also includes an input device 208 that receives inputs from the user (i.e., user inputs) such as, for example, coupon selections, etc. The input device 208 is coupled to the processor 202 and may include, for example, a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

In addition, the illustrated computing device 200 also includes a network interface 210 coupled to the processor 202 and the memory 204. The network interface 210 may include, without limitation, a wired network adapter, a wireless network adapter, a mobile network adapter, or other device capable of communicating to one or more different networks, including the network 114. Further, in some exemplary embodiments, the computing device 200 includes the processor 202 and one or more network interfaces incorporated into or with the processor 202.

Referring again to FIG. 1, in operation, the coupon engine 110 accesses one or more stores of coupons, either available to the public from merchants (such as the merchant 102) or manufacturers or through exchanges such as the coupon provider 112, etc. As described more in method 300, the coupon engine 110 is generally configured, via computer-executable instructions, to assign start values to the coupons, for example (and without limitation), based on face values of the coupons and/or expiration dates for the coupons. The coupon engine 110, in this embodiment, then weights the start values based on various parameters associated with the coupons and, potentially, various parameters associated with the redemption merchants for the coupons. The parameters may include, for example, stores per region for redemption merchants associated with the coupons, terms and conditions of the coupons, restrictions associated with the coupons, and various rankings (e.g., social media rankings, POS coupon rankings, trending transaction rankings, etc.) for the coupons and/or redemption merchants. As a result, the face values of the coupons are initially adjusted and weighted, as desired, relative to other coupons. In at least one embodiment, weighting of the start value of a coupon, after it is assigned, may be omitted (such that the assigned value for the coupon is the start value).

The coupon engine 110 is also configured to store the values assigned to the coupons, and any corresponding weightings associated therewith as described herein, in memory 204 of the computing device 200 associated with the coupon engine 110, or in other memories. Further, the coupon engine 110 is configured to publish the assigned coupon values to various entities, including, for example, coupon exchanges (e.g., the coupon provider 112, etc.), merchants, consumers (e.g., consumer 114), etc. As can be appreciated, the assigned values provide a metric by which the consumer 114 may exchange coupons with another consumer (not shown). The assigned values may also allow the merchant, a coupon exchange such as coupon provider 112, etc. to display, rank, etc. coupons relative to each other for purchase or exchange. The assigned values also allow the merchant 102, and other merchants, to investigate the effectiveness of its coupons among consumers, for example, based on the assigned values and comparative rankings with other coupons (e.g., other types of coupons offered by the same merchants, coupons of other merchants, etc.), etc.

Further, the coupon values determined by the coupon engine 110, i.e., the assigned coupon values, generally represent real time values for the coupons, i.e., present day values. The assigned values can be updated as desired (e.g., continuously, hourly, daily, weekly, monthly, at other time periods, etc.), so that an up-to-date record of the coupon values can be maintained or used by merchants, coupon brokers, coupon exchanges, consumers, or others. Such updating also may help represent the values of the coupons over time (and show changes therein, for example, following various particular events sponsored by merchants, times of year, etc.).

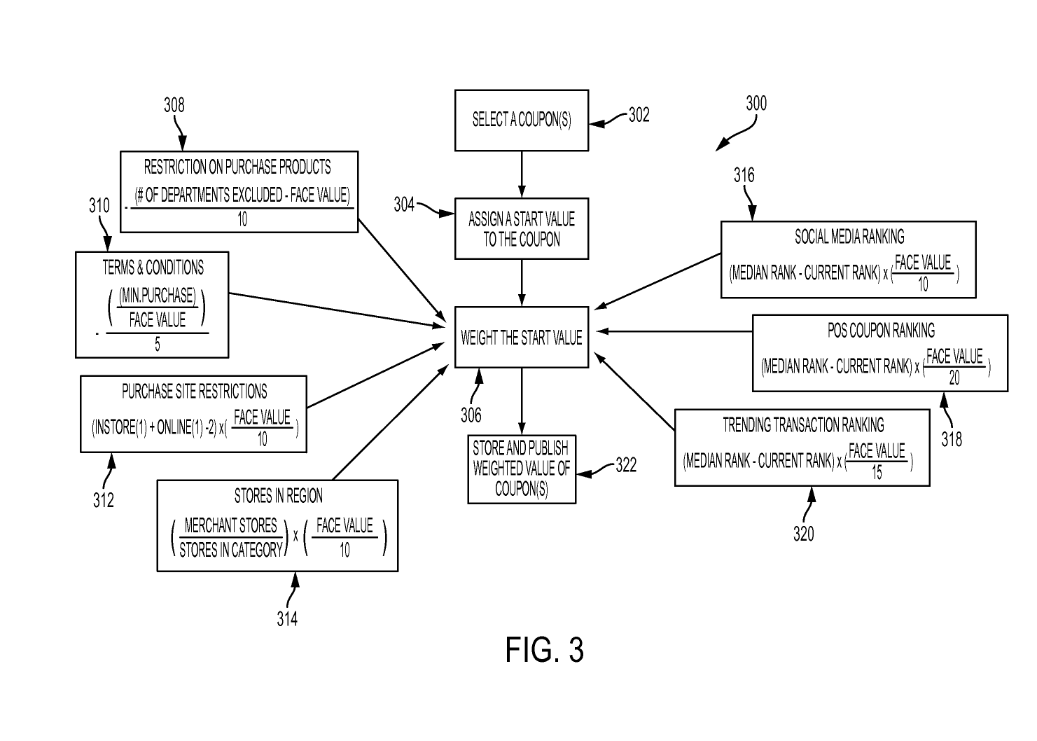

FIG. 3 illustrates an exemplary method 300 for assigning a value to a coupon, based on one or more parameters associated with the coupon. The exemplary method 300 is described as implemented in the coupon engine 110 of the system 100. However, the method 300 is not limited to the coupon engine 110, or to the system 100, and, as such, may be implemented in other entities of the system 100 or in other systems. Further, for purposes of illustration, the exemplary method 300 is described herein with reference to the computing device 200. The methods herein should not be understood to be limited to the exemplary system 100 or the exemplary computing device 200, and the systems and the computing devices herein should not be understood to be limited to the exemplary method 300.

The method 300 is described herein with reference to Table 1. As shown, Table 1 includes six exemplary coupons, coupons 1-6. Aspects of the method 300 are described next with reference to the particular coupons 1-6. The method 300, however, should not be understood to be limited to any of the particular coupons 1-6, or type of coupon, shown in Table 1 (or to any particular coupon or type of coupon in general). In various embodiments, any type of coupon and/or any number coupons may be subjected to the method 300 to assign a value thereto, or to similar methods herein, within the scope of the present disclosure.

Coupons 1-6 in Table 1 are redeemable at one of merchants A-C, which are all in the same category, i.e., all have the same merchant category code (MCC) (in this example). The coupons 1-6 each include a face value, in US dollars, for example, and an expiration date, between 30-60 days from the present date. Certain restrictions on the coupons 1-6 are represented by letters in Table 1 relating to excluded departments and/or products. For example, and without limitation, “J” represents jewelry, “L” represents fashion accessories, “K” represents shoes, “N” represents shoe accessories, “M” represents men's clothing, “B” represents boys clothing, “W” represents women's clothing, and “C” represents cosmetics. In addition, Table 1 indicates the terms and conditions (or T & C) for each of the coupons 1-6 with regard to minimum spend required to redeem the coupons 1-6, as well as redemption mode for the coupons 1-6, i.e., in store, online, or both.

Apart from data relating to the coupons 1-6, Table 1 also includes particular parameters of the redemption merchants A-C, i.e., the merchants at which the particular coupons may be redeemed. Specifically, as shown, merchant A includes 100 locations in the region, while merchant B includes 50 locations in the region and merchant C includes 200 locations in the region. It should be appreciated that the region may vary in different embodiments, and the number of redemption locations may span multiple different merchants. For example, a general 5% product coupon may be redeemed at multiple different merchants spanning a large region (e.g., grocery coupons for redemption at different grocery store chains, etc.), rather than at just one merchant or one brand of merchant.

Further, Table 1 includes multiple rankings for the coupons 1-6 and/or the merchants A-C. The rankings include social media rankings, point of sale (POS) redemption (or redeem) rankings, and trending rankings. The rankings may be calculated by the coupon engine 110, or they may be calculated by other entities and then accessed by the coupon engine 110 as appropriate. The social media rankings show the merchant rankings, in a particular industry or MCC, relative to all of the merchants (or groups of merchants) in the same industry or MCC. More particularly, the social media rankings represent popularity weight/rankings of the coupons based on conversations in the social media relating to the coupons or the particular redemption merchants. For example, merchants that have a high discussion rate or count, or a more positive discussion or review may receive higher rankings. The POS redemption rankings, for the coupons, indicate the rankings of the coupons, based on coupon redemption at particular merchants. This can be based on total numbers of such coupons redeemed, rates at which such coupons are redeemed, etc. The merchants A-C may also be ranked in spending, number of transactions, size, etc., relative to one or more other merchants, in general, or in the same industry, having the same MCC, or relative to any other subset of merchants, etc. The trending rankings, included in Table 1, represent rankings indicative of transaction numbers, versus multiple other merchants.

TABLE 1

| | Coupon 1 | Coupon 2 | Coupon 3 | Coupon 4 | Coupon 5 | Coupon 6 |
|---|---|---|---|---|---|---|
| | Merchant A | Merchant A | Merchant B | Merchant B | Merchant C | Merchant C |
| Face Value | $10 | $10 | $5 | $10 | $5 | $10 |
| Expires | 30 | 30 | 60 | 60 | 30 | 30 |
| (days) | | | | | | |
| Restrictions | J, L | K, N | K, M, B | K, N, M, W | M, W | J, C |
| T & C | Min. $30 | Min. $10 | Min. $0 | Min. $10 | Min. $10 | Min. $50 |
| In Store/ | In Store/ | In Store/ | In Store | In Store/ | In Store | Online |
| Online | Online | Online | Only | Online | Only | Only |
| Stores in | 100 | 100 | 50 | 50 | 200 | 200 |
| Region | | | | | | |
| Social | 3 | 3 | 1 | 1 | 2 | 2 |
| Media | | | | | | |
| Ranking | | | | | | |
| POS | 1 | 1 | 2 | 2 | 3 | 3 |
| Redeem | | | | | | |
| Ranking | | | | | | |
| Trending | 2 | 2 | 3 | 3 | 1 | 1 |
| Ranking | | | | | | |

It should be appreciated that the various parameters of the coupons 1-6 above are provided for purposes of illustration. The same or different, or more or less, parameters of coupons may be used in a variety of other implementations of the method 300, and in other methods consistent with the present disclosure.

Referring now to FIG. 3, the coupon engine 110 identifies a target coupon, at 302, and assigns a start value to the coupon, at 304. The target coupon is associated with redemption merchant 102, in method 300. The start value may be any value used as a starting point for determining a value for the coupon, in relation to other coupons. For example, the start value may include a face value of the coupon, or another value that may be based on the face value, or even other start values as desired. It should be appreciated that the start value, as used herein, is not necessarily limited to a monetary value (e.g., in US dollars), but may include any value, which is expressed in a manner that permits consumers to compare coupons, relatively, as described herein. In one example, a start value is a numeric value on a scale of 1-100. In another example, a start value is a letter rating from A-F (which may be assigned to a coupon based on a score assigned and/or weighted, according to the methods herein, being within one or more ranges).

In the method 300, for example, the coupon engine 110 assigns a start value (or discounted face value) to the coupon based on equation (1), which takes into account a discount rate for the coupon and an expiration date of the coupon. The discount rate includes, for example, a prevailing U.S. treasury rate (e.g., as available from the U.S. Department of the Treasury, etc.), or other suitable rate, etc. for maturity of the coupon close to an expiration period remaining for the coupon.

$$Start Value = \frac{( Face Value )}{{( 1 - Discount Rate )}^{Number of Months}} \qquad ( 1 )$$

In various implementations of the method 300, different coupons are normalized so that start values can be calculated for coupons with different offers, for example, coupons offering percentages off purchase prices, coupons offering dollar amounts off purchase prices, coupons offering buy one, get one free for certain products, etc. As such, the different coupons can be compared to each other.

For example, coupons offering percentages off purchase prices and coupons offering buy one, get one free for certain products may be rationalized close to similar dollar amount off coupons. Equation (1) can then be used to determine start values for the normalized coupons. In this example, a coupon offering 20% off from merchant A on a minimum purchase of $100 may be normalized as (or may be assigned a similar dollar value as) a coupon offering $20 off from merchant A on a minimum purchase of $100. A weighting may then be added to the start value of the coupon to account for the percentage form of the coupon (verses the normalized dollar form), since the 20% off aspect of the coupon actually becomes a better price than the $20 discount when the price of the purchased product increases (e.g., a 15% positive weighting may be applied to the start vale of the coupon, etc.). Similarly, a coupon offering a discount of buy one get one 50% off, with a purchase of one item having a minimum value of $100, may be normalized as a coupon offering $50 off on a minimum purchase of $200. Further, a coupon offering a discount of buy one get one X % off, without a minimum purchase value defined, may be normalized based on historical online purchases using similar coupons from POS data, etc.

It should be appreciated that the start value may be determined and assigned in a variety of different ways in other embodiments, for example, other than using equation (1). In at least one example, the expiration date of the coupon is not used to assign a start value, but is instead a parameter used to weight the coupon, consistent with step 306 in method 300. Conversely, any of the parameters described with reference to weighting herein may further, or alternatively, be employed to generate and assign a start value.

With reference again to FIG. 3, once the start value is assigned to the target coupon, the coupon engine 110 weights the start value, at 306, based on one or more parameters of the coupon, the coupon merchant 102, the user 116, etc. The weights can be positive (adjusting the start value up, for example, as described above in connection with normalizing coupons) or negative (adjusting the start value down), and can be based on a variety of different parameters. For example, in the method 300, the different parameters include assigned values for general restrictions associated with the coupon (at 308), T & C restrictions associated with the coupon (at 310), purchase site redemption restrictions associated with the coupon (at 312), available stores within a region at which the coupon can be used (at 314), social media rankings (at 316), POS redemption rankings (at 318), and trending rankings (at 320). Other parameters include, without limitation, redemption restrictions, expiration dates, number of stores in a region, other rankings, comparisons of face values of the coupons and average spend amounts at the corresponding redemption merchants, and/or various other data associated with the merchants, the coupons, etc., or modifications and/or combinations thereof. It should be understood, however, that weighting coupons' start values may be based on more or fewer parameters, or even different parameters associated with the coupons, or the corresponding redemption merchants, etc., as desired. It should further be appreciated that any one or more of the above parameters may be employed in assigning a start value, in addition to being employed in weighting the start value consistent with step 306, in the exemplary embodiment.

Table 2 includes assigned start values (or discounted face values) for the coupons 1-6 in Table 1, as determined by the coupon engine 110 using equation (1). Table 2 also includes multiple weighting factors used to adjust the start values of the coupons 1-6, in connection with determining final assigned (and weighted) values, or total values, of the coupons 1-6. In Table 2, the weighting factors include values for general restrictions associated with the coupons 1-6, for T & C restrictions associated with the coupons 1-6, for purchase site restrictions associated with the coupons 1-6, for available stores within a region at which the coupons 1-6 can be used, for the social media rankings of the coupons 1-6, for the POS redemption rankings of the coupons 1-6, and for the trending rankings of the coupons 1-6.

TABLE 2

| | Coupon 1 | Coupon 2 | Coupon 3 | Coupon 4 | Coupon 5 | Coupon 6 |
|---|---|---|---|---|---|---|
| Start Value | $10.10 | $10.10 | $5.10 | $10.20 | $5.05 | $10.10 |
| Restriction | −$2.00 | −$2.00 | −$1.50 | −$4.00 | −$1.00 | −$2.00 |
| T & C | −$0.60 | −$0.20 | $0.00 | −$0.20 | −$0.40 | −$1.00 |
| Purchase | $0.00 | $0.00 | −$0.50 | $0.00 | −$0.50 | −$1.00 |
| Site | | | | | | |
| Restriction | | | | | | |
| Stores In | $0.29 | $0.29 | $0.07 | $0.14 | $0.29 | $0.57 |
| Region | | | | | | |
| Social | −$1.00 | −$1.00 | $0.50 | $1.00 | $0.00 | $0.00 |
| Media | | | | | | |
| Ranking | | | | | | |
| POS | $0.50 | $0.50 | $0.00 | $0.00 | −$0.25 | −$0.50 |
| Redemption | | | | | | |
| Ranking | | | | | | |
| Trending | $0 | $0 | −$0.333 | −$0.666 | $0.33 | $0.666 |
| Ranking | | | | | | |
| Total | $7.29 | $7.69 | $3.34 | $6.48 | $3.52 | $6.84 |

In connection with weighting (or adjusting) the start value of the target coupon in method 300, the coupon engine 110 determines, at 308, a weighting based on the number of restrictions on the redemption of the coupon. In the method 300, this includes multiplying the number of departments, in which the coupon is not redeemable, by the face value of the coupon and then dividing by 10, i.e., ((# of excluded departments×face value)/10) (as shown in FIG. 3). With reference to Tables 1 and 2, using this calculation, coupon 3, which has three excluded departments (K, M, and B), for example, includes a weighting of −$1.50, i.e., (−(3×$5)/10). The weighting is negative for this factor because the number of restrictions on the departments, at the merchant B, for which the coupon may be redeemed, are equal to or greater than the reduction in value of the coupon by this weighting factor. It should be appreciated that, depending on the types of departments, or other metrics of restrictions, one or more different calculations may be employed to determine a weighting, in view of the restrictions for what the coupons may be redeemed.

At 310, the coupon engine 110 determines a weighting based on the terms and conditions (T & C), and in particular in method 300 the minimum purchase requirement for redemption of the coupon. In connection with this factor, as minimum purchase requirement increases, the value of the coupon is lowered, i.e., the weighting is generally negative. For example, the weight, based on terms and conditions of the coupon, may be calculated as the negative of the minimum purchase requirement, divided by the face value of the coupon and then divided by five, i.e., ((min. purchase requirement/face value)/5) (as shown in FIG. 3). With reference to Tables 1 and 2, using this calculation, coupon 2 is weighted by −$0.20, i.e., (−($10/10)/5). Again, different calculations and/or equations may be employed to weight the assigned value of the coupon based on the minimum purchase, or based on other terms and conditions of the coupon, etc.

At 312, the coupon engine 110 determines a weighting based on purchase site restrictions of the target coupon, and in particular whether redemption is accepted online, or in the store, or both. For example, in the method 300, this weighting factor may be calculated by assigning 1 point for acceptance in-store, 1 point for acceptance online, and subtracting 2 from that total, and then multiplying the result by the face value of the coupon divided by 10, i.e., ((InStore (1)+Online (1)−2)×(face value/10)) (as shown in FIG. 3). With reference to Tables 1 and 2, coupon 5 is only accepted in stores and has a face value of $5. As such, using this calculation, coupon 5 is weighted by −$0.50, i.e., ((1-2)×($5/10)). Again it should be appreciated that this particular method of weighting the value of the coupon, based on acceptance location types, is exemplary and that other methods may be different in other embodiments.

At 314, the coupon engine 110 determines a weighting based on the number of stores in the region, at which the target coupon may be redeemed. In the method 300, this weighting is based on the number of stores in the region (e.g., based on city, ZIP code, county, state, country, etc.) divided by the total number of stores in the category, multiplied by the face value divided by 10, i.e., ((merchant stores that accept coupon/total stores in merchant category)×(face value/10)) (as shown in FIG. 3). With reference again to Tables 1 and 2, because each of the merchants A, B, and C are in the same category, coupon 1, for example, is weighted, using this calculation, by $0.29, or ((100/350)×($10/10)).

In connection with this weighting factor, at 314, the category may be based on merchant category code (MCC) of the redemption merchant 102 for the target coupon, or industry, or other metric indicative of whether or not, for example, the redemption merchant 102 is in competition with other merchants. Still other information may be used to determine the stores in the category. For example, when the coupon is generic to multiple different merchants, the determination of the weighting for stores in the region may be the same or different. Specifically, for a $2.50 coupon for cereal from the manufacturer, the coupon may be redeemable at most, if not all, grocery stores in the region, i.e., 10 in this example. The weighting would then be the face value divided by 10 (or $0.25). As can be seen, the wide acceptance of the $2.50 coupon has roughly (within $0.04) the same weighting as a $10 coupon with acceptance in less than a third of the stores in the category. It should be appreciated that weighting based on stores per region may be determined otherwise in different embodiments.

With continued reference to FIG. 3, the coupon engine 110 determines a weighting for the target coupon based on a social media ranking for the redemption merchant 102 at 316, for example, relative to other merchants. The weighting is, specifically, the median ranking of a category of merchant (in social media), in which the redemption merchant 102 is associated, minus the current ranking of the merchant 102, multiplied by the face value of the target coupon divided by 10, or ((median rank−current rank)×(face value/10)) (as shown in FIG. 3). The ranking may account for one social media source, or multiple different social media sources, etc. Often, the social media source will relate to the merchant 102, or at least a product offered for sale by the merchant 102, and/or may be published by industry associations, or other interested or disinterested entities. In Table 2, using this calculation, coupon 4 is weighted by $1.00, i.e., ((2−1)×($10/10)).

At 318, the coupon engine 110 determines a weighting for the target coupon based on a POS coupon ranking of either the coupon or the redemption merchant 102. Specifically, the coupon engine 110 relies on the rank of the coupon/merchant 102, relative to other coupons/merchants, based on for example, popularity (e.g., counts of redemptions, etc.), frequency of the redemption, percentage of redemptions, etc. For example, a coupon that is redeemed at a rate of 31%, should be weighted different, at 318, as compared to a coupon that is redeemed at a rate of 6% (potentially further depending on volume of redemptions, etc.). In connection with this operation of method 300, the coupon engine 110 may access redemption ranking data for the merchant 102, and/or for other merchants, at, for example, data structure in memory 204 of the coupon engine 110, from the payment network 106, from other entities in the system 100, etc. The coupon engine 110 then determines the weighting by subtracting the current rank of the coupon/merchant 102 from the median rank of all related coupons/merchants and then multiplying the difference by the face value of the coupon divided by 20, or ((median rank−current rank)×(face value/20)) (as shown in FIG. 3). In Table 2, using this calculation, coupon 6 is weighted by −$0.50, i.e., ((2−3)×($10/20)).

At 320, the coupon engine 110 determines a weighting for the target coupon based on a trending transaction ranking for the redemption merchant 102. The weighting is determined as the median rank of the redemption merchant 102 (in the category in which the merchant 102 is associated) minus the current ranking of the merchant 102, multiplied by the face value of the target coupon divided by 15 or ((median rank−current rank)×(face value/15)) (as shown in FIG. 3). The trending transaction ranking is generally based on the frequency, amount and/or volume of transactions at the redemption merchant 102 and, often, also on the category or type of the redemption merchant 102. Trending transaction ranking data may be obtained from the payment network 106, or from other entities shown or not shown in FIG. 1. In general, a merchant involved in more transactions than a similarly situated merchant (e.g., having the same MCC, offering the same products for sale, located in the same region, etc.) is a preferred redemption merchant for a coupon, as captured by the weighting at 320. In Table 2, using this calculation, coupon 6 is weighted by $0.666, i.e., ((2−1)×($10/15)).

Once the weightings are determined, alone, or in combination, the coupon engine 110 applies the weightings to the start value, as part of operation 306. The resulting value is the assigned value, or weighted value, for the coupon. For the coupons 1-6 in Tables 1 and 2, this includes adding each of the weightings to the start value to provide the final, adjusted value of the coupons 1-6 (shown in Table 2). As can be seen, for example, the assigned value for coupon 1 went from $10.10 to $7.49; the assigned value for coupon 2 went from $10.10 to $7.69; the assigned value for coupon 3 went from $5.10 to $3.34; the assigned value for coupon 4 went from $10.20 to $3.52; the assigned value for coupon 5 went from $5.50 to $3.52; and the assigned value of coupon 6 went from $10.10 to $6.84.

It should be appreciated that while a number of different types of weightings are described with reference to FIG. 3, and Tables 1 and 2, that any different kinds of weightings may be employed, relying on these parameters and others, to determine the relative value of coupons. In particular, for example, certain parameters may be more useful to weight coupons in particular categories, while not as useful in other categories. In at least one embodiment, some, but not all, of the parameters relied on in FIG. 3 may be employed to weight a start value for a coupon, or other value of the coupon, by the coupon engine 110, or by another part of the system 100, in other system embodiments. In at least one embodiment, the weighting of a coupon start value, or assignment of a start value, may be based on the category of the coupon and/or redemption merchant, and as such, may be different for different coupons. For example, a first group of coupons may be for a first category of merchants, for which a first one or more parameters are used to weight and/or assign a value to each coupon, and a second group of coupons may be for a second different category of merchants, for which one or more different parameters (potentially without one or more common parameters) are used to weight and/or assign a value to each coupon.

Finally in FIG. 3, once the assigned (and adjusted, or weighted) coupon value is determined for the target coupon, the coupon engine 110 stores the value in memory 204, and publishes the value, at 322. Generally, the value is stored in memory 204 of computing device 200 associated with the coupon engine 110, for example.

Publication of the assigned coupon value may be done in a variety of manners. In some embodiments, the value may be transmitted (broadly, published) to the redemption merchant 102 and/or one or more other merchants, or to a particular subset of merchants who are associated with the coupon engine 110. For example, merchants may subscribe to services offered by the coupon engine 110 to determine the values of coupons offered by the merchants, relative to other similar or different coupons offered by other merchants. The coupon values determined by the coupon engine 110, and the corresponding values determined for other coupons, may then be provided in a report to the subscribing merchants, or may generally be accessible at a website (not shown) associated with the coupon engine 110.

As previously described, the assigned coupon values determined by the coupon engine 110 can be updated, as desired, by repeating various operations of the method 300. In so doing, the determined values can represent up-to-date, current values of the coupons for use by merchants, consumers, exchanges, or others.

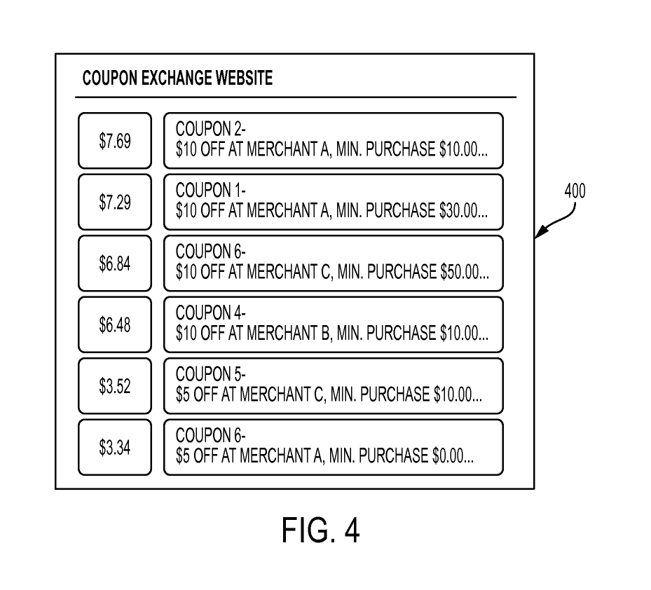

In other embodiments, the assigned coupon value determined by the coupon engine 110, for the target coupon, may be published to one or more exchange websites, either associated or not, with the coupon engine 110. When not associated, the coupon engine 110 may be accessed, for example, via an API, from the exchange website server (not shown). FIG. 4 illustrates an example interface 400 in which the assigned coupon values for coupons 1-6 in Tables 1 and 2 are shown, with the coupons 1-6 further ranked in order of the assigned coupon values. In this manner, a consumer, such as consumer 116, accessing the coupon exchange website, would be able to readily assess the relative values of the coupons through the interface 400, to determine whether or not to exchange, buy, or sell one or more of the coupons 1-6. In some embodiments, the interface 400 may also link to the identified coupons.

It should be appreciated that the values, weight values, etc., as described herein, may be used in a variety of different ways to provide information about the relative value of coupons, as defined by the methods provided herein, and variations thereof.

In this manner, values (or scores) can be assigned to coupons as representations of a true (or approximated) value of the coupons to consumers, relative to other related (or not) coupons. Uniquely, the assigned values take into account multiple different factors that provide insight into coupon popularity and demand by the consumers. In this manner, a common metric, or value scale, is provided, by which the different coupons can more efficiently and accurately be ranked, compared, exchanged, etc.

In some aspects of the present disclosure, issuers may provide applications (e.g., mobile applications for smartphones, etc.) to consumers associated with payment devices issued by the issuers. The issuers can then use the applications to showcase coupons and other offers. The coupons may me ranked, as described herein, and may further be combined with historic spending, for example, by the consumers on merchant categories, etc. to provide, enable, identify, etc. what coupons to showcase or include in various rankings or including in various listings of ranked coupons.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) selecting, by a computing device, a target coupon; (b) weighting, by the computing device, a value associated with the coupon, based on at least one parameter related to the coupon and/or a redemption merchant associated with the coupon; (c) publishing the weighted value of the target coupon, whereby the weighted value is usable to compare the target coupon to weighted values of other coupons; (d) assigning a start value to the target coupon, based on an a face value of the coupon and an expiration date of the coupon; (e) weighting the start value based on at least one restriction on redemption of the coupon in combination with the face value of the coupon, based on a number of location associated with the redemption merchant in a region, as compared to a number of locations for merchants in a shared industry category with the redemption merchant, and/or based on a ranking of the redemption merchant relative to one or more other merchant, the ranking defined by a transaction volume for the redemption merchant and transaction volumes for the other merchants; (f) weighting the value based on at least one of a minimum purchase requirement for the coupon, an expiration period of the coupon, and a restriction on a site of redemption for the coupon, and/or based on a comparison of a face value of the coupon and an average spend at the redemption merchant; and/or (g) publishing the weighted value of the target coupon, along with multiple other weighted values for multiple other coupons, in order according to the weighted value.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” or “included with” another element or layer, it may be directly on, engaged, connected or coupled to, or associated with the other element or layer, or intervening elements or layers may be present. As used herein, the term “and/or” includes any and all combinations of one or more of the associated listed items.

In addition, as used herein, the term product may include a good and/or a service.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in scoring target coupons relative to other coupons, the method comprising:
selecting, by a computing device, a target coupon;
weighting, by the computing device, a value associated with the target coupon, based on at least one parameter related to the target coupon and/or a redemption merchant associated with the target coupon; and
publishing the weighted value of the target coupon, whereby the weighted value is usable to compare the target coupon to weighted values of other coupons.

2. The computer-implemented method of claim 1, further comprising assigning a start value to the target coupon, based on a face value of the target coupon and an expiration date of the target coupon; and
wherein weighting a value associated with the target coupon includes weighting the start value of the target coupon.

3. The computer-implemented method of claim 2, wherein the at least one parameter related to the target coupon includes at least one restriction on redemption of the target coupon; and
wherein weighting the start value includes weighting the start value based on the at least one restriction on redemption of the target coupon in combination with the face value of the target coupon.

4. The computer-implemented method of claim 2, wherein the at least one parameter related to the target coupon includes a number of locations associated with the redemption merchant in a region, as compared to a number of locations for merchants in a shared industry category with the redemption merchant.

5. The computer-implemented method of claim 2, wherein the at least one parameter related to the target coupon includes a ranking of the redemption merchant relative to one or more other merchant, the ranking defined by a transaction volume for the redemption merchant and transaction volumes for the other merchants.

6. The computer-implemented method of claim 1, wherein the at least one parameter related to the target coupon includes at least one of a minimum purchase requirement for the target coupon, an expiration period of the target coupon, and/or a restriction on a site of redemption for the target coupon.

7. The computer-implemented method of claim 1, wherein weighting a value associated with the target coupon is further based on a comparison of a face value of the target coupon and an average spend at the redemption merchant.

8. The computer-implemented method of claim 1, wherein publishing the weighted value includes publishing the weighted value of the target coupon, along with multiple other weighted values for multiple other coupons, in order according to the weighted value; and
wherein the target coupon and the other coupons include at least one of a common category, a common product, and a common industry.

9. The computer-implemented method of claim 1, further comprising assigning a start value to the target coupon, based on a face value of the target coupon; and
wherein the at least one parameter related to the target coupon includes a minimum purchase requirement for the target coupon.

10. A non-transitory computer readable storage media including computer executable instructions that, when executed by at least one processor, cause the at least one processor to:
assign a start value to each of multiple coupons based on at least a face value associated with the each coupon;
for each coupon, weight the start value based on at least one parameter associated with the coupon; and
store and publish the weighted values for the multiple coupons.

11. The non-transitory computer readable storage media of claim 11, wherein the multiple coupons include a first group of coupons and a second group of coupons; and
wherein the at least one parameter is different for coupons in the first group, as compared to the at least one parameter for coupons in the second group.

12. The non-transitory computer readable storage media of claim 11, further including computer executable instructions that, when executed by the at least one processor, cause the at least one processor, in order to weight the start value for each coupon, to:
determine a weight based on at least one restriction on redemption of the coupon at the redemption merchant; and
subtract the weight from the start value.

13. The non-transitory computer readable media of claim 11, further including computer executable instructions that, when executed by the at least one processor, cause the at least one processor, in order to weight the start value for each coupon, to:
access a data structure including one or more ranking for the multiple merchants, each merchant included within a category and each merchant associated with at least one of the multiple coupons; and
weight the start value based on a difference between a ranking of the redemption merchant, for said coupon, and an average ranking of the other merchants.

14. The non-transitory computer readable media of claim 11, further including computer executable instructions that, when executed by the at least one processor, cause the at least one processor, in order to assign the start value, to assign the start value based on at least an expiration of the coupon.

15. The non-transitory computer readable media of claim 11, further including computer executable instructions that, when executed by the at least one processor, cause the at least one processor, in order to publish the weighted values, to publish the weighted values to an interface, associated with a website, in which the coupons are ordered based on weighted value.

16. A system for use in ranking coupons relative to other coupons, the system comprising:
a memory; and
at least one processor coupled to the memory and configured to:
access multiple coupons, each of the multiple coupons associated with a redemption merchant;
weight values associated with each of the multiple coupons, based on at least one parameter of the coupons and/or corresponding redemption merchants, and store the weighted values in the memory; and
publish the weighted values of the coupons, in an order of the values, whereby the weighted values are usable to compare the coupons.

17. The system of claim 16, wherein the at least one processor is further configured to assign a start value to each of the multiple coupons, based on at least a face value associated with the each coupon, and weight the start value for each of the coupons based on the at least one parameter of the coupons and/or the corresponding redemption merchants;
wherein the at least one parameter is stored in the memory for access by the at least one processor.

18. The system of claim 17, wherein the at least one processor is further configured to access rankings for the multiple coupons and/or corresponding redemption merchants, and weight the start value for each of the coupons based on the rankings.

19. The system of claim 17, wherein the at least one processor is further configured to weight the start value for each of the multiple coupons based on at least one restriction on redemption of the coupon at the corresponding redemption merchant.

20. The system of claim 17, wherein the at least one processor is further configured to assign the start value based on at least an expiration of the coupon.
